(19) United States
(12) Patent Application Publication
(10) Pub. No.: US 2011/0203252 A1
(43) Pub. Date: Aug. 25, 2011

(54) DEVICE FOR THE PRODUCTION OF ENERGY FROM BIOMASS

(75) Inventor: Jean-Paul Gautreau, Sainte Eulalie (FR)

(73) Assignee: EBV, Montfort L'amaury (FR)

(21) Appl. No.: 12/921,236

(22) PCT Filed: Mar. 6, 2009
(86) PCT No.: PCT/FR09/50372

§ 371 Date: Sep. 7, 2010

(30) Foreign Application Priority Data
Mar. 7, 2008 (FR) 0851491

(51) Int. Cl. F02C 6/00

(52) U.S. Cl. 60/39.181

(57) ABSTRACT

A device for the production of energy from biomass, includes:
a first train of shafts to which are connected a compressor and a first turbine,
a first exchanger that ensures heat exchanges between a so-called working fluid that was first compressed by the compressor and expanded into the first turbine, and hot gases that are obtained from the combustion of the biomass,
a second train of shafts to which are connected a second turbine and elements for converting kinetic energy into another energy,
a second exchanger that ensures heat exchanges between a working fluid that supplies the second turbine, and hot gases that are obtained from the combustion of the biomass, wherein
the working fluid that is used in the second turbine is the working fluid that exits from the compressor, without passing through the first turbine.

This invention relates to a device for the production of energy, in particular electrical and thermal energy, from biomass.

In the energy field, biomass is defined as all of the organic materials that can become energy sources. They can be used either directly, for example by combustion of solid material such as wood, or indirectly: after gasification, namely by transforming a solid fuel into a gaseous fuel, after methanization, namely a degradation of the organic material, or in liquid form.

These energy sources have the advantage of having a quantitative balance of CO₂ that is essentially in equilibrium. Actually, even if the combustion discharges CO₂ into the atmosphere, the latter was first sampled and transformed into matter, by photosynthesis, for example.

In a known manner, the biomass can be transformed into electrical energy in installations that operate according to a conventional vapor cycle.

Even if vapor-cycle electrical power plants are tried and true, these installations are designed for electrical production on the order of several megawatts to obtain an advantageous yield, taking into account their complexity, in particular due to the implementation of a secondary fluid in two-phase evolution.

In a known manner, the biomass can be transformed into electrical energy in devices that operate according to the principle of Stirling-type engines. However, even if these installations have high yields, they are designed for the production of several kilowatts.

Although there are numerous sources of biomass generated by human activity, the latter are generally dispersed, and their volume is not suitable either for the vapor-cycle electrical power plants or for the installations that operate according to the principle of the Stirling engines.

Even if in some cases the biomass can be collected and transported for the purpose of being used in vapor-cycle electrical power plants of large production capacities, transportation leads to disruption of the CO₂ balance and to reduction of the profitability.

Consequently, there is a need for so-called intermediate installations that make it possible to obtain a satisfactory yield in the intermediate ranges on the order of several kilowatts to one megawatt.

In the field of the production of energy by transportation of heat energy into kinetic energy, internal combustion gas turbines are known. In this case, a working fluid, in general naturally oxidized, passes through a compressor so as to increase its pressure. Next, the working fluid undergoes a rise in temperature, generally by mixing said working fluid with a fuel that carries out a combustive reaction. Finally, the working fluid is expanded in a turbine.

These internal combustion turbines generally have high yields. However, they can use only one fuel that does not contain any particles that can damage the component parts of the turbine and are limited to fuels that can be fully evaporated and that are clean, such as natural gas, the fully purified gases, and the filtered refined liquid products.

Consequently, the internal combustion turbines cannot use a fuel such as biomass that is loaded with impurities.

The document DE3112648 describes a system for the production of energy with internal combustion that comprises a first train of shafts to which are connected a compressor and a first turbine, whereby a first exchanger ensures the heat exchanges between, on the one hand, a so-called working fluid that was previously compressed by said compressor, subsequently used as an oxidizer in a first combustion chamber and then expanded in said first turbine, and, on the other hand, hot gases that are obtained from combustion of the biomass. This system comprises a second train of shafts to which are connected a second turbine and means for converting the kinetic energy into another energy, whereby said second turbine is fed by fluid obtained from the first turbine and previously heated in a second heat exchanger. The fluid that exits from the second turbine is used as an oxidizer in a second combustion chamber that is used for heating the first exchanger and then in a third combustion chamber that is used for heating the second exchanger. As above, the working fluid that successively passes through the two turbines is obtained from combustion, which induces the above-cited drawbacks.

According to one embodiment, it is possible to use external combustion with two turbines in series. This variant does not make it possible to optimize the yield as will be explained below.

So as to remedy this drawback, it is possible to use gas turbines with external combustion. In this case, the combustion is performed in a conventional manner in a dedicated chamber at atmospheric pressure, whereby the elevation of the temperature of the working fluid is performed in an exchanger in which the hot gases that are produced during the combustion circulate.

According to a so-called single-cycle operating principle, a compressor and a turbine that are placed on the same line of shafts are used.

In a first step, a working fluid, generally ambient air, is compressed in the compressor. This compression makes it possible to obtain an increase in pressure but also a first elevation of temperature of the working fluid.

Next, the working fluid undergoes a rise in temperature by passing through an exchanger in which the hot gases that are produced during the combustion of the biomass circulate.

Finally, the working fluid is expanded in a turbine that causes the rotation of the rotor of the turbine that drives the common shaft line. Thus, a portion of the energy is used to drive the compressor; the remaining energy can be converted into electrical energy by using an electric current generator.

However, an operation according to a single cycle does not make it possible to optimize the yield of the energy production.

To improve this yield, solutions have been considered, in particular in the document US-2001/0015060.

To improve the yield, one technique consists in recovering a portion of the energy that is lost in the turbine exhaust, either to preheat the fuel or to preheat another fluid called a secondary fluid that is used in a vapor cycle to produce energy or to provide additional calories during the rise in temperature of the working fluid between the compressor and the turbine.

The preheating of the fuel does not lead to an optimum increase of the yield.

The recovery of the heat to preheat a second fluid that is used in a vapor cycle makes it possible to increase the yield. However, it leads to complicating the installation in particular because of the use of a fluid undergoing two-phase development. Consequently, it is difficult to moderate these kinds of installations for energy production levels ranging from several KW to 1 MW.

The recovery of heat that is obtained from the working fluid with turbine exhaust to preheat the working fluid at the outlet of the compressor is not optimum and is limited according to the known techniques.

Thus, when a choice is made to improve the yield by increasing the compression level, this is also reflected by an additional elevation of the temperature of the working fluid at the outlet of the compressor, which reduces the range of recovery of the heat of the working fluid all the more at the outlet of the turbine.

If a choice is made to improve the yield by increasing the temperature of the working fluid at the inlet of the turbine, in particular using the heat that is recovered at the outlet of the turbine, the limits are then technological, for example the behavior at high temperatures of the materials of the component parts of the turbine.

The document NL-51521 describes a system for energy production that comprises a first train of shafts to which are connected a compressor and a first turbine, a first exchanger ensuring the heat exchanges between, on the one hand, a so-called working fluid previously compressed by said compressor and then expanded in said first turbine, and, on the other hand, hot gases that are obtained from a combustion chamber. This system comprises a second train of shafts to which are connected a second turbine and means for converting kinetic energy into another energy, whereby said second turbine is supplied with fluid obtained from the first turbine and previously heated in a second heat exchanger placed in the combustion chamber. The fluid that exits from the second turbine is used as an oxidizer in a combustion chamber that is used to heat the first exchanger and the second exchanger.

This solution does not make it possible to optimize the yield.

Also, the purpose of this invention is to overcome the drawbacks of the devices of the prior art by proposing a device for the production of energy, in particular electrical energy, from biomass, making it possible to optimize the yield, with a simple design so as to make an intermediate installation economically viable for the production of energy ranging from several KW to 1 MW.

For this purpose, the invention has as its object a device for the production of energy from biomass, comprising:

A first train of shafts to which are connected a compressor and a first turbine,

A first exchanger that ensures heat exchanges between, on the one hand, a so-called working fluid that was first compressed by said compressor and expanded into said first turbine, and, on the other hand, hot gases that are obtained from the combustion of the biomass,

A second train of shafts to which are connected a second turbine and means for converting kinetic energy into another energy,

A second exchanger that ensures heat exchanges between, on the one hand, the working fluid that supplies said second turbine, and, on the other hand, hot gases that are obtained from the combustion of the biomass,

characterized in that

The working fluid that is used in said second turbine is obtained from the compressor without passing through the first turbine.

Other characteristics and advantages will emerge from the following description of the invention, a description that is provided only by way of example, relative to the accompanying drawings in which:

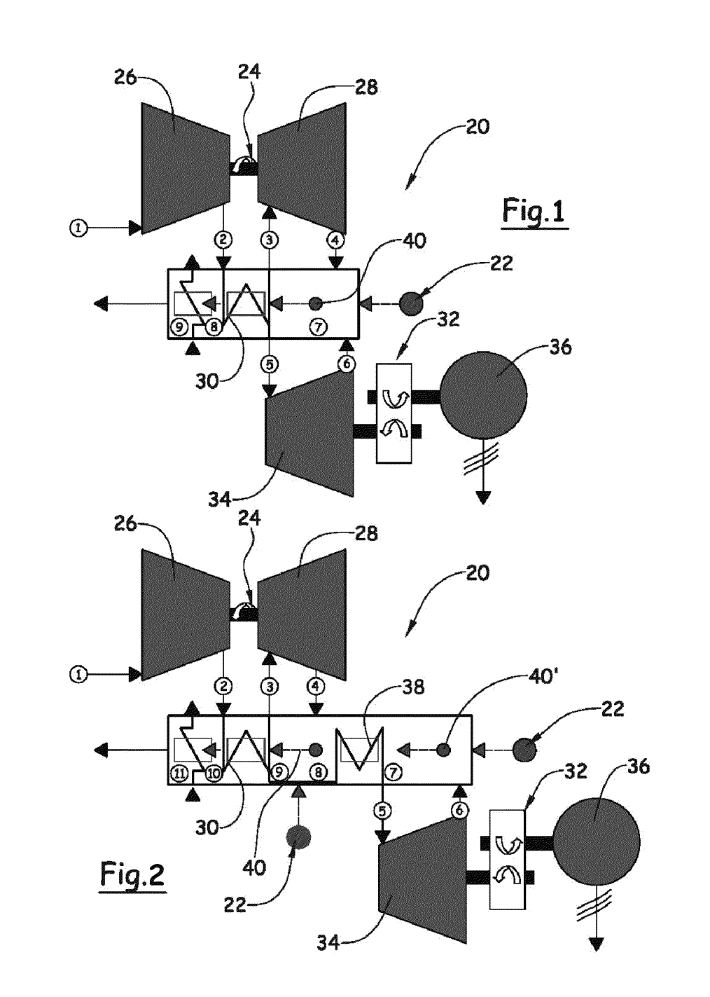

FIG. 1 is a diagram that illustrates a first variant of a device for the production of energy according to the invention,

FIG. 2 is a diagram that illustrates another variant of a device for the production of energy according to the invention,

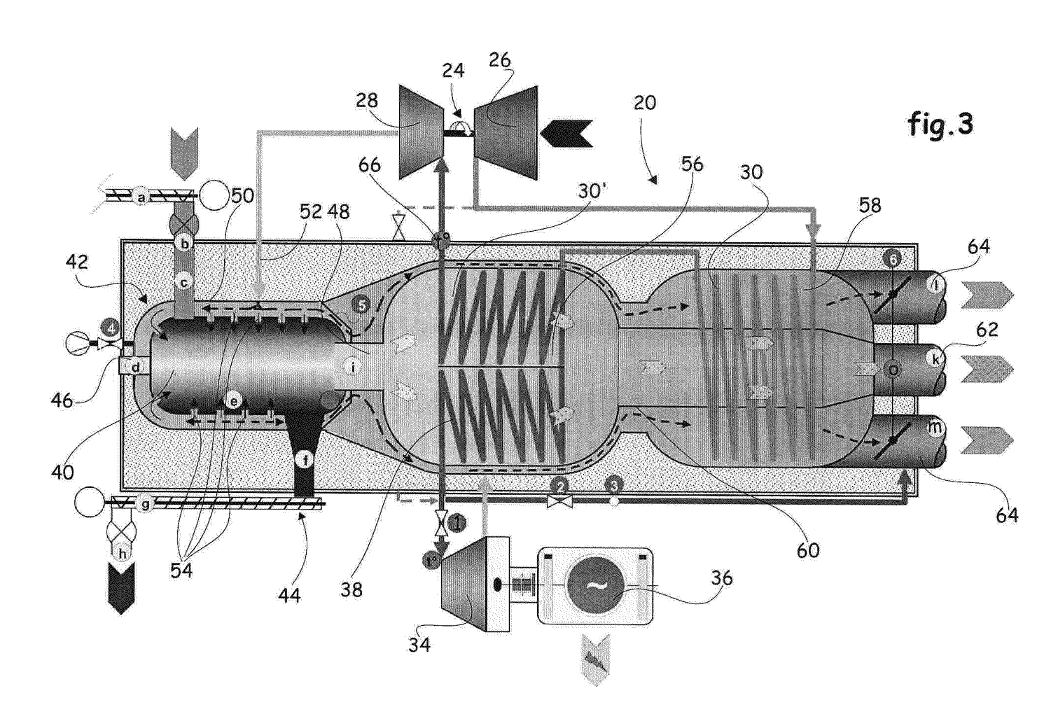

FIG. 3 is a general outline that illustrates a production device according to the invention, and

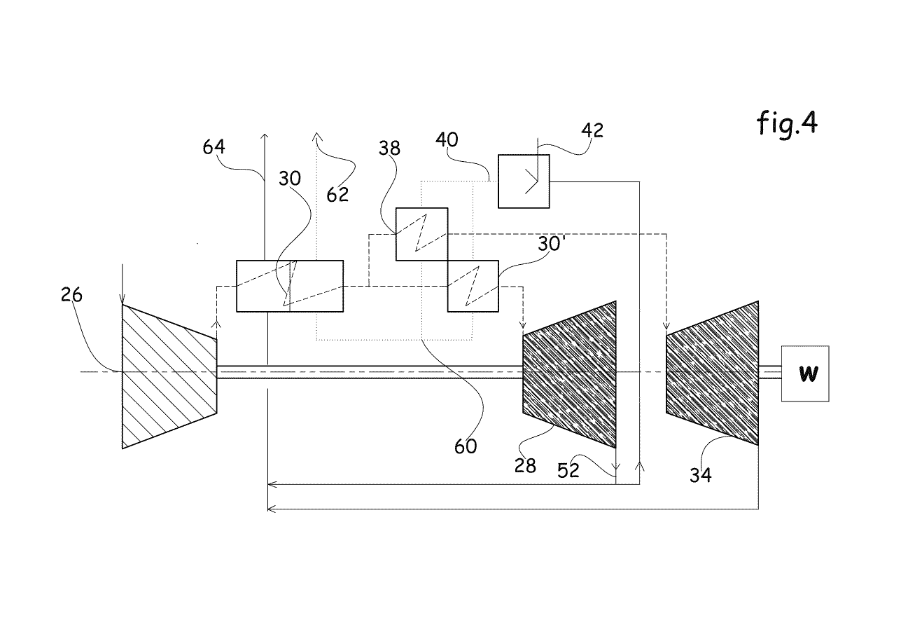

FIG. 4 is a diagram of the device that is visible in FIG. 3.

In all of the figures, a device for the production of energy, in particular electrical energy, from a biomass source 22, is shown at 20.

Biomass is defined as all of the organic materials that can become energy sources.

The device 20 for the production of energy comprises, on the one hand, a first train 24 of shafts that comprises at least one rotary shaft on which are mounted a compressor 26 and a first turbine 28, and, on the other hand, a first exchanger 30 that comprises a first fluid circuit that is designed for a so-called working fluid, previously compressed by the compressor 26 and expanded in the first turbine 28.

Advantageously, the working fluid is the ambient air that can be filtered in advance.

For the remainder of the description, turbine is defined as a means in which a fluid expands by producing kinetic energy. This turbine can have different configurations.

Shaft train is defined as one or more shafts that are linked kinematically.

Exchanger is defined as a means with which are performed heat exchanges between two elements, in particular between a working fluid and hot gases that are obtained from direct or indirect combustion of the biomass.

According to the illustrated examples, the working fluid circulates in a fluid circuit at the exchanger that is placed in a vein of hot gases. However, other solutions can be considered to ensure this heat transfer. According to the variants, the heat exchanges can be of static or dynamic type.

By way of example, in the case of a static exchanger, tubes, plates and/or alveolar structures are arranged to facilitate the heat exchanges between the two flows of fluids that are perfectly airtight between them.

By way of example, in the case of a dynamic exchanger, it is possible to use an alveolar structure in the form of a preferably ceramic disk that rotates on itself. The flow of hot gases charges a sector of the disk that accumulates heat at its alveolar structure whereas the flow of the working fluid to be heated is charged thermally upon contact of the alveolar structure with another sector of the previously heated disk.

The dynamic exchangers have smaller space requirements with identical yields.

Direct combustion of the biomass means that the biomass undergoes a chemical oxidation reaction. By way of example, wood chips can be burned in a combustion chamber for generating hot gases.

Indirect combustion of biomass means that the biomass undergoes a first reaction, for example a gasification, namely a transformation of a solid fuel into a gaseous fuel, or a methanization, namely a degradation of the organic material, so as to produce gases that are next burned to produce hot gases.

By way of example, the biomass can be gasified in a gasifier that is combined with a cyclone.

According to the invention, the characteristics of the compressor 26, the turbine 28 and/or the exchanger 30 are determined so as not to generate residual energy. Thus, at the rotary shaft, the turbine 28 delivers only the kinetic energy that is necessary for the compressor 26.

The device for the production of energy comprises a second train 32 of shafts that comprises at least one shaft on which are mounted a second turbine 34 and means 36 for converting kinetic energy into electrical energy, etc.

According to the invention, the working fluid that is used in the second turbine is the same working fluid that has passed through the compressor 26 but not the first turbine.

According to one embodiment, the conversion means 36 come in the form of a current generator. According to the illustrated examples, the second train 32 of shafts can comprise at least two shafts, a first shaft that is connected to the second turbine 34, and a second shaft that is connected to the conversion means 36, whereby the two shafts are connected by coupling means.

According to the invention, the working fluid, prior to its introduction into the second turbine 34, passes through at least one exchanger that comprises a fluid circuit that is designed with the so-called working fluid.

According to the invention, an arrangement of turbines in parallel is provided, and the working fluid is introduced into the second turbine 34 after its passage into the compressor 26 without first passing through the first turbine 28.

According to a first variant that is illustrated in FIG. 1, the working fluid is introduced into the second turbine after having passed through the first exchanger 30. In this case, the working fluid that is not used by the first turbine 28 is expanded in the second turbine 34 under the same conditions as the first turbine.

According to one embodiment, the second turbine 34 is connected to the first exchanger 30 and means for regulating flows are provided at the outlet of the first exchanger so as to adjust the flow of working fluid oriented toward each of the two turbines. According to one embodiment, a regulation of discharging pressure arranged at the inlet of the turbine 34 is used to keep the pressure constant in the pipes provided for the working fluid.

This solution has the advantage of providing only a single combustion chamber and a single exchanger.

According to another variant that is illustrated in FIGS. 2 and 3, the working fluid is introduced into the second turbine after having passed through a second exchanger that is arranged in series with the first exchanger. In this case, the working fluid that is not used by the first turbine 28 is expanded in the second turbine 34 at the same pressure but at a generally higher temperature.

This variant is preferred to the variant that is illustrated in FIG. 1 because it makes it possible to differentiate the temperatures of the working fluid at the inlet of the turbines 28 and 34 and thus to optimize the operation of the two turbines and to improve the yield.

If appropriate, the device for the production of energy can comprise a single combustion chamber 40 as illustrated in FIG. 3 or two combustion chambers 40, 40′, one for the first exchanger 30 and another for the second exchanger 38.

According to one embodiment, the working fluid that exits from the first turbine 28 and/or the second turbine 34 can be used to preheat the fuel in at least one of the combustion chambers to improve the yield of the combustion.

This configuration makes it possible to significantly increase the yield of the unit because the heat of the working fluid that is used as an oxidizer makes it possible to increase the calorific power of the combustion.

Advantageously, the oxidizer that is used in at least one of the combustion chambers is the working fluid that exits from at least one turbine 28 and/or 34.

According to one embodiment that is illustrated in detail in FIGS. 3 and 4, the working fluid, namely ambient air, penetrates the compressor 26 via, for example, a muffler, then successively passes through a first exchanger 30, another exchanger 30′, the first turbine 28, and then supplies a combustion chamber 40. At the outlet of the first exchanger 30, a portion of the air is directed either toward the exchanger 30′ or toward a second exchanger 38, and then the second turbine 34.

The combustion chamber 40 comprises a supply of fuel 42 that successively comprises an endless screw for metering fuel, an alveolar gate valve for isolating flows, and a fuel injection nozzle that empties into the combustion chamber.

In the lower part, the combustion chamber 40 comprises means for evacuating ashes 44 that successively comprise a hopper for recovery of ashes, an endless screw for extracting ashes, and an alveolar gate valve for isolating flows.

The combustion chamber 40 has an essentially cylindrical shape with a flame guide 46 at a first end and a bottleneck 48 at the other end for the passage of smoke and hot combustion gases.

The combustion chamber 40 is arranged in a chamber 50 that is connected by a feed 52 to the outlet of the first turbine 28. The hot air that is obtained from said first turbine 28 is used as an oxidizer. It circulates between the shell of the chamber 50 and that of the combustion chamber and is injected at least partially into said combustion chamber by connection pieces 54 (or nozzles for injecting hot combustive air) made at the periphery of the combustion chamber 40.

The bottleneck 48 is connected to a first exchange chamber 56 in which are arranged the exchangers 30′ and 38 that respectively supply the turbines 28 and 34. The chamber 50 also surrounds the first exchange chamber 56, with the hot air that comes from the first turbine 28 circulating between the shell of the chamber 50 and the first exchange chamber 56.

The chamber 50 then extends in the form of a second exchange chamber 58 that is concentric to an exhaust pipe 60 that ensures the transfer of hot gases that come from the first exchange chamber 56 to an exhaust 62 at which they are treated before being discharged into the atmosphere.

According to one embodiment, the first exchanger 30 is arranged in the second exchange chamber 58 in a concentric manner to the exhaust pipe 60.

According to another illustrated variant in particular in FIG. 3, the exchanger 30 comprises at least one pipe in which the working fluid that is placed in the second exchange chamber 58 and in the exhaust pipe 60 circulates. Thus, this exchanger ensures a heat transfer, on the one hand, between the air exiting from the compressor and the hot gases that come from the combustion, and on the other hand, between the air exiting from the compressor and the hot air exiting from the turbines.

The hot air that circulates in the chamber 50 is discharged through at least one evacuation pipe 64.

To control the supply of fuel, it is possible to provide a temperature sensor 66 at the inlet of the first turbine 28.

By way of example, in relation to FIG. 3, the air has a temperature on the order of 15° C. and a pressure on the order of 1.013 bar (A) at the inlet of the compressor. At the outlet of the compressor, the air has a temperature of 162° C. and a pressure of 3.44 bar (A).

At the outlet of the first exchanger 30, the air has a temperature of 371° C. At the outlet of the exchanger 30′ and at the inlet of the first turbine 28, the air has a temperature on the order of 700° C. At the outlet of the exchanger 38 and at the inlet of the second turbine, the air has a temperature on the order of 550° C.

After its passage into the first turbine, the air has a pressure on the order of 1.013 bar (A) and a temperature on the order of 480° C. At the first turbine, a AQ is obtained on the order of 1,932 kW that is equivalent to that of the compressor.

After its passage into the second turbine, the air has a pressure on the order of 1.013 bar (A) and a temperature on the order of 361° C. At the second turbine, a AQ is obtained on the order of 1,044 kW that is reflected by an electrical production on the order of 981 kWh.

At the combustion chamber, the hot air that is used as an oxidizer has a temperature on the order of 480° C., and the hot gases at the outlet of the combustion chamber have a temperature on the order of 1050° C. This rise in temperature is generated by burning 806 kg/h of wood in the form of sawdust or calibrated wood with a grain size that is less than 30 mm, for a water content of 9% gross weight and/or the specific consumption of 3,847 kWh PCI.

According to the invention, the device makes it possible to obtain an electrical yield on the order of 0.26 and an overall yield of 0.61 when the smoke is cooled separately from the exhaust air at 120° C. by co-generation. It is possible to note that the exhaust air that represents 60% of the waste is clean air, not contaminated by smoke, and that the latter can be used directly for any heating and/or recovery operation without condensation up to ambient temperature.

1. Device for the production of energy from biomass, comprising:
A first train (24) of shafts to which are connected a compressor (26) and a first turbine (28),
A first exchanger (30) that ensures heat exchanges between, on the one hand, a so-called working fluid that was first compressed by said compressor (26) and expanded into said first turbine (28), and, on the other hand, hot gases that are obtained from the combustion of the biomass,
A second train (32) of shafts to which are connected a second turbine (34) and means (36) for converting kinetic energy into another energy,
A second exchanger (38) that ensures heat exchanges between, on the one hand, a working fluid that supplies the second turbine (34), and, on the other hand, hot gases that are obtained from the combustion of the biomass
characterized in that
The working fluid that is used in said second turbine (34) is the working fluid that exits from the compressor (26) without passing through the first turbine (28).

2. Device for the production of energy from biomass according to claim 1, wherein the characteristics of the compressor (26), the turbine (28) and/or the exchanger (30) are determined in such a way that the turbine (28) produces the energy corresponding strictly to the energy that is necessary for the compressor (26).

3. Device for the production of energy from biomass according to claim 1, wherein the means for regulating the flows are provided at the outlet of the first exchanger (30) so as to adjust the flow of working fluid oriented toward each of the two turbines.

4. Device for the production of energy from biomass according to claim 3, wherein the second turbine (34) is connected to a second exchanger (38) that is arranged in series with the first exchanger (30).

5. Device for the production of energy from biomass according to claim 1, wherein the working fluid that exits from at least one turbine (28, 34) is used as an oxidizer in at least one combustion chamber.

6. Device for the production of energy from biomass according to claim 1, wherein it comprises a chamber (50) in which there is arranged a combustion chamber (40) that is connected upstream to a biomass supply and downstream to a first exchange chamber (56) that is extended by an exhaust pipe (60) of hot gases, with the hot air that comes from the first turbine (28) circulating between, on the one hand, the shell of said chamber (50), and, on the other hand, the shells of the combustion chamber (40), the exchange chamber (56) and the exhaust pipe (60), whereby at least one portion of said hot air is introduced via a number of connection pieces into the combustion chamber.

7. Device for the production of energy from biomass according to claim 6, wherein the first exchanger (30) is arranged in a second exchange chamber (58) that is delimited by the chamber (50) and the exhaust pipe (60).

8. Device for the production of energy from biomass according to claim 6, wherein the first exchanger (30) comprises at least one pipe in which the working fluid that is placed in a second exchange chamber (58), delimited by the chamber (50) and the exhaust pipe (60), and in the exhaust pipe (60) circulates.

9. Device for the production of energy from biomass according to claim 6, wherein it comprises an exchanger (30′) that is inserted between the first exchanger (30) and the first turbine (28) that is arranged in the first exchange chamber (56).

10. Device for the production of energy from biomass according to claim 9, wherein the second exchanger (38) is arranged in the first exchange chamber (56).

11. Device for the production of energy from biomass according to claim 2, wherein the means for regulating the flows are provided at the outlet of the first exchanger (30) so as to adjust the flow of working fluid oriented toward each of the two turbines.

12. Device for the production of energy from biomass according to claim 11, wherein the second turbine (34) is connected to a second exchanger (38) that is arranged in series with the first exchanger (30).

13. Device for the production of energy from biomass according to claim 7, wherein it comprises an exchanger (30′) that is inserted between the first exchanger (30) and the first turbine (28) that is arranged in the first exchange chamber.

14. Device for the production of energy from biomass according to claim 8, wherein it comprises an exchanger (30′) that is inserted between the first exchanger (30) and the first turbine (28) that is arranged in the first exchange chamber
